(19) United States
(12) Patent Application Publication
(10) Pub. No.: US 2017/0255499 A1
(43) Pub. Date: Sep. 7, 2017

(54) HYBRID QUORUM SYSTEM WITH PERSISTENT AND NON-PERSISTENT

(71) Applicant: International Business Machines Corporation, Armink, NY (US)

(72) Inventors: Guy Laden, Jaffa (IL); Yoav Tock, Haifa (IL); Ilya Shnayderman, Jerusalem (IL)

(21) Appl. No.: 15/062,227

(22) Filed: Mar. 7, 2016

(51) Int. Cl. G06F 9/52; G06N 99/00; H04L 29/08

(52) U.S. Cl. CPC G06F 9/52; H04L 67/1095; G06N 99/005

(57) ABSTRACT

A hybrid quorum system capable of supporting both persistent and non-persistent operations is disclosed. A computerized system, computerized apparatus, computer program product and method useful for providing a hybrid quorum system are disclosed. A replicated process in a Replicated State Machine (RSM) is configured to receive transient operations and perform such operations without storing the transient operations in a persistent storage of the replicated process. The replicated process is further configured to receive persistent operations and accordingly store such operations in a persistent storage, such as in an operation log, and perform the operations.

### TECHNICAL FIELD

The present disclosure relates to quorum systems capable of agreeing on an order of operations.

### BACKGROUND

Replicated State Machine (RSM) is a general method for providing high availability and fault-tolerant services, e.g. software services. In this method, the state machine of the service is replicated and maintained across multiple processes, also referred to as the replica-set, and updated via a sequence of commands which are fed to each of the processes in a globally consistent order. By processing the commands in the same order and in a deterministic fashion, the state of each of the processes in the replica-set can progress in a synchronized and consistent manner.

For application developers, using a replicated service is generally more convenient when from their perspective it behaves like a service running on single non-replicated server. For example this enables application developers to avoid dealing with anomalies such as performing a write and then having it not be visible due to a server failure. Replicated services that are able to assure that powerful invariants about data semantics hold are said to provide ‘strong consistency’ semantics. On example of consistent replication is the Paxos family of quorum based systems. The Paxos algorithm allows a collection of processes that may propose values to agree on a single value chosen from among the plurality of proposed values. The algorithm contemplates three classes of roles performed by the processes in the collection: proposers, acceptors, and learners. A proposed value is sent by a proposer to a set of acceptors, each of which may accept the proposed value. Paxos requires that a value is chosen only if it was accepted by some majority of acceptors, referred to as “quorum”. A learner learns that a value was chosen by finding out that a proposal has been accepted by a majority of acceptors. A leader process is chosen to play the role of distinguished proposer, being the only one to try issuing proposals, as well as the role of distinguished learner, being the only one acceptors respond to and responsible to inform other learners. The algorithm is depicted in L. Lamport. The part-time parliament. ACM Trans. Comput. Syst., 16(2):133-169, 1998, which is hereby incorporated by reference without giving rise to disavowment.

### BRIEF SUMMARY

One exemplary embodiment of the disclosed subject matter is a computer-implemented method performed by a server that implements a replicated process in a Replicated State Machine (RSM) that utilizes a quorum system to agree upon an order of operations, said method comprising: receiving a first operation in the RSM, wherein the first operation is a transient operation; performing the first operation without storing the first operation in a persistent storage of the server; receiving a second operation in the RSM, wherein the second operation is a persistent operation; and storing the second operation in the persistent storage of the server and performing the second operation.

Another exemplary embodiment of the disclosed subject matter is a server implementing a replicated process in a Replicated State Machine (RSM) that utilizes a quorum system to agree upon an order of operations, wherein the server comprises a processor, the processor being adapted to perform the steps of: receiving a first operation in the RSM, wherein the first operation is a transient operation; performing the first operation without storing the first operation in a persistent storage of the server; receiving a second operation in the RSM, wherein the second operation is a persistent operation; and storing the second operation in the persistent storage of the server and performing the second operation.

Yet another exemplary embodiment of the disclosed subject matter is a computer program product comprising a computer readable storage medium retaining program instructions, which program instructions when read by a processor of a server implementing a replicated process in a Replicated State Machine (RSM) that utilizes a quorum system to agree upon an order of operations, cause the processor to perform a method comprising: receiving a first operation in the RMS, wherein the first operation is a transient operation; performing the first operation without storing the first operation in a persistent storage of the server; receiving a second operation in the RSM, wherein the second operation is a persistent operation; and storing the second operation in the persistent storage of the server and performing the second operation.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 showing an illustration of a computerized environment, in accordance with some exemplary embodiments of the disclosed subject matter;

FIG. 2 showing a flowchart diagram of a method, in accordance with the disclosed subject matter; and

FIG. 3 showing an apparatus, in accordance with some exemplary embodiments of the disclosed subject matter.

### DETAILED DESCRIPTION

One technical problem dealt with by the disclosed subject matter is to improve performance of a Paxos-based quorum system.

In traditional Paxos-based systems, the replicas write all replicated data to a disk-based log, which protects against the failure of the servers. However failure of all servers in a replicated system is quite rare, especially since many systems today replicate across multiple data-centers/availability zone for disaster recovery. In some exemplary use cases of the system, under realistic assumptions, persisting to disk might be unnecessary for much of the typical data in a replicated system. Writing to disk may create an overhead and reduce performance as in such system a request can be ordered only after majority of replicas are sure that the request is stored on the stable storage. It is a known fact that writing to disk is a relatively slow operation. In some cases, there may be a hardware limitation as to the number of Input/Output Operations Per Second (IOPS) to hard disks, such as a few hundreds. Hence, replication performance may be s improved if access to disk could be avoided in some cases.

One technical solution is to enable Paxos-based algorithms to support two classes of replicated data: data that is to be persisted to disk and data which is to be replicated without persisting to disk. The quorum system may have a hybrid set of operations which comprise both persistent operations (POs), and non-persistent operations, also referred to as Transient Operations (TOs). Regular operations may be operations which are stored and are guaranteed to be the same in case of recovery. Transient operations may not be stored and data relevant thereto is not guaranteed to be recoverable.

In some exemplary embodiments, Paxos-based systems support consistent read operations by performing a dummy write operation, i.e. one with no real data, after which it is guaranteed that reads from the local replica will see the latest cluster data. A dummy write operation may be defined as a transient operation.

In some exemplary embodiments, membership related operations may be defined as transient operations. In some cases, a dynamic set of servers that form the replica-set, also referred to as “members”, is maintained. This set of members may be made highly-available via replication in a Paxos-like system. A membership service may detect and remove from the set any servers which have failed. To this end, typically a periodic heartbeat message is sent from a member to notify that it is still available and functioning as a member. It is noted that a passive membership service is not guaranteed to be a fully accurate reflection of the system, such as for example in case of severs that continue to function but are not reachable by the membership service in view of a network failure. In view of the above, updates to the membership service may be deemed non-persistent. In the rare case that enough servers fail that data is lost, this is similar to the situation that the set of servers does not fully correspond to reality because of e.g. network issues. Any such possible inaccuracies need to be dealt with by a component using the membership service. Some users of a membership service, e.g. those using for leader election, may require that at some points in time membership information is not lost, as the actions taken depend on the membership information at this point of time.

In some exemplary embodiments, each new operation may comprise a new operation ID. The operation ID may be a monotonically increasing sequence-number that is increased for every operation. The operation ID may be composed of a major number and a minor number. As an example, the operation ID may be a 64 bit number with the major number comprising the most significant 48 bits and the remaining 16 bits representing the minor number. In some exemplary embodiments, regular operations increase the major number, while transient operations increase the minor number. Only after regular operations information is stored to disk. In some exemplary embodiments, only the regular operation is stored. Additionally or alternatively, when a regular operation is performed, all the transient operations that have not yet been written to disk, as well as the newly received regular operation, are written to storage and retained in a log.

In some exemplary embodiments, such an embodiment provides a performance improvement as transient operations are performed without disk access. Additionally or alternatively, overall system throughput may be increased as batch of transient operations are written to disk together using a single sequential disk access which may be more efficient than multiple individual accesses.

In the case of failure of any number of replicas which forms at most a minority of the replicas, as the replicas recover they will synchronize their state with the cluster. So in this case no operations will be lost, neither non-persistent nor persistent operations.

Upon failure of a majority of the replicas, regular operations are guaranteed to be recovered correctly. Transient operations, such as the transient operations performed after the last regular operation, may not be recovered. In addition, upon recovery, an operation ID may not uniquely identify the transient operations, as the minor number may be advanced in view of new operations in a recovered network partition before unification of the network partitions. For example, upon recovery major number X and minor number 0 may be recovered at startup. Before unification additional transient operations may be received and agreed upon, advancing the minor number in the partition to Y. The non-recovered network partition may be independently set at major X, minor Y as well, in view of potentially different transient operations occurring after last persistent operation.

In some exemplary embodiments, identification of two transient operations have the same operation ID may be performed based on collision free hash values of each state of a server. Hence, in case the operation ID comprises a minor number, hash value may be computed and used in addition to the operation ID to uniquely identify the operation.

In some exemplary embodiments, at unification the system may be required to be consistent, and it may require to identify that the transient operations are not the same between the two or more partitions, so as to allow selection one of them as the correct version and sync all other replicas to the same version. In the above example, the non-recovered partition may lose Y transient operations previously accepted and gain new Y transient operations that were performed by the recovered partition.

In some exemplary embodiments, one of the conflicting sets of transient operations may be discarded so that the replica-set is put in a consistent state. In some exemplary embodiments, the leader election phase of Paxos may be utilized to resolve such conflicts. When a new leader is elected the leader may collect information from at least majority of replicas. If a transient operation is not collected during this stage it can be lost as the leader will propose another command to the replica-set.

In some exemplary embodiments, speculative execution may be utilized. The mechanism of speculative execution was suggested for efficient continuous operation of replica sets between reconfigurations, as is depicted in U.S. Pat. No. 8,943,178 entitled CONTINUOUS OPERATION DURING RECONFIGURATION PERIODS, by Vita Bortnikov et al, issued on 27 Jan. 2015, and in V. Bortnikov et al. FRAPPE’: Fast Replication Platform for Elastic Services. In ACM LADIS (2011) (hereinafter FRAPPE), both of which are hereby incorporated by reference in their entirety without giving rise to disavowment. In some exemplary embodiments, a speculative branch may be created before a set of new TOs are decided upon and selected when a PO is selected. The speculative branch is opened, potentially using a Dummy Speculative Configuration (DSC) operation, before processing a TO. The DSC may comprise the same configuration exactly as was before and is used simply to leverage the speculative configuration mechanism to be useful for the disclosed subject matter. However, in some embodiments, DSC may not be used and a speculative mechanism may be implemented to directly address the issue of TOs and POs in accordance with the disclosed subject matter. All TOs received and agreed upon after the DSC are speculatively delivered. The speculative branch is committed once PO is received. At such time, all TOs and the PO are written to stable storage before the acceptance of PO is confirmed. Hence, PO may be ordered and delivered after a quorum of replicas wrote all the preceding TOs to the stable storage.

In some exemplary embodiments, in case that no PO operation has arrived for a long time replicas can run out of memory. In order to solve this, the leader can periodically, such as after agreeing on a predetermined threshold number of TOs, suggest a dummy PO or determine to handle a next TO as a PO. This may allow replicas to write to a stable storage some of TOs and frees them from requirement to store those operations in volatile memory. In some exemplary embodiments, the threshold number may be associated with a number of potential consecutive transient operations the minor number in the operation ID can represent. For example, in case the minor number is of 16 bits, no more than 65,536 consecutive TOs are supported.

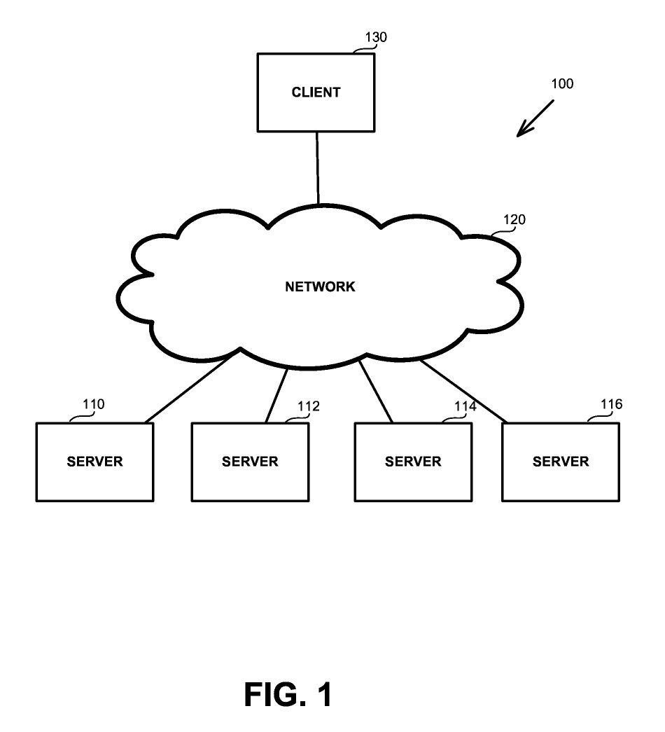

Referring now to FIG. 1 showing an illustration of a computerized environment, in accordance with some exemplary embodiments of the disclosed subject matter.

Environment 100 comprises an RSM composed of a set of replicated machines, such as provided by Servers 110, 112, 114, 116, which are interconnected via a Network 120. The RSM may comprise any number of replicated machines and is not limited in any manner to the exemplary embodiment of four servers. The RSM may serve client machines, such as 130, which may or may not be aware of the fact that they are utilizing a state machine that is replicated on a set of machines.

Each RSM command advancing the state of RSM may be determined to either be a PO or a TO. In some exemplary embodiments, there may be a predetermined definition of which operations are considered to be TOs. In some exemplary embodiments, the determination regarding an instance operation may be based on the predetermined definition. Additionally or alternatively, the determination may also take into account a number of consecutive TOs previously agreed upon by the RSM, time elapsed since last PO command, or the like, so as to force committing information to persistent storage by determining a next operation that can be TO to be PO instead or s alternatively to issue a dummy PO. In some exemplary embodiments, forcing committing information may be useful for memory utilization purposes to free up volatile memory, to reduce the risk of data loss, or the like.

In response to a TO, Servers 110, 112, 114, 116 may agree upon the operation without writing the TO into the log retained in persistent storage.

In response to a PO, Servers 110, 112, 114, 116 may write the PO into the log. In some exemplary embodiments, Server 110, 112, 114, 116 may also write to the log all or some of the consecutive TOs preceding the PO which were not yet written to the log. The log may be accessed in a single write operation to write both the consecutive TOs and PO.

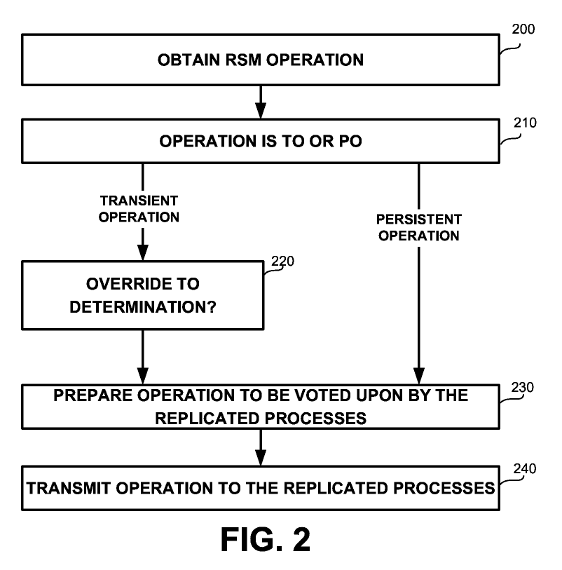

Referring now to FIG. 2 showing a flowchart diagram of a method, in accordance with the disclosed subject matter.

On Step 200, an RSM operation may be obtained. The RSM operation is an operation to be provided to all replicated processes of the RSM.

On Step 210, a determination as to the nature of the RSM operation is made, determining whether the RSM operation is a PO or TO. In some exemplary embodiments, the determination may be based on a predetermined definition of POs and TOs in the RSM.

In case the operation is TO, an override decision may be made on Step 220. If the override decision is made, the TO will be handled as a PO. The override decision may be determined in case a predetermined limit of consecutive TOs was reached, such as the maximal number the minor number in the operation ID allows for. Additionally or alternatively, the TO decision may be overridden to allow to free volatile memory by the replicated processes. Additionally or alternatively, the decision may be overridden if a threshold time has elapsed since last PO, or the like.

On Step 230, the operation is prepared to be transmitted to the replicated processes. In some exemplary embodiments, a TO is allocated an operation ID by increasing a minor number of an ID of a previous operation, while a PO is allocated an operation ID by increasing a major number of the ID of a previous operation.

Additionally or alternatively, in case the TO immediately succeed a PO, a speculative branch may be started, such as by generating a DSC operation that precedes the TO or by indicating the TO itself is to be treated as an operation that creates a new speculative branch. In case a PO immediately succeeds a TO, or is otherwise part of a speculative branch that is not yet committed, the PO may be configured to cause the speculative branch to be committed. In some exemplary embodiments, a commit operation may be generated and transmitted together with the PO.

On Step 240, the operation is transmitted to the replicated processes to be handled by each process. In some exemplary embodiments, a quorum decision may be made as to whether the operation is performed or not in the RSM. In case the operation is PO, performing the operation also entails writing the operation to the log of each replicated process.

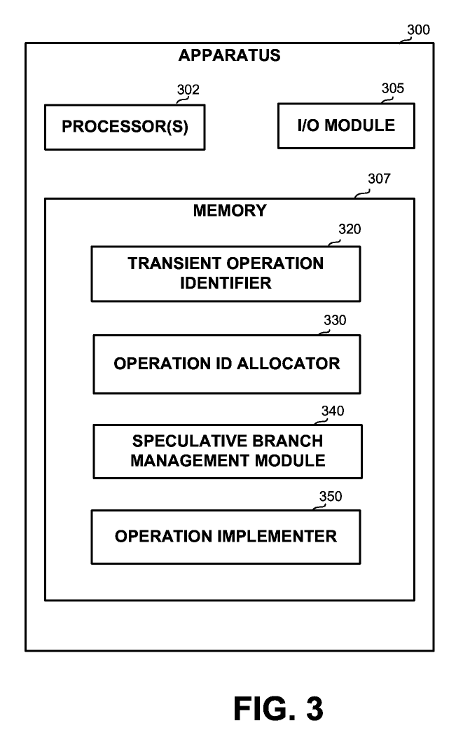

Referring now to FIG. 3 showing an apparatus, in accordance with some exemplary embodiments of the disclosed subject matter.

In some exemplary embodiments, Apparatus 300 may be configured to act as a replicated state machine process in a replica-set in accordance with the disclosed subject matter.

In some exemplary embodiments, Apparatus 300 may comprise one or more Processor(s) 302. Processor 302 may be a Central Processing Unit (CPU), a microprocessor, an electronic circuit, an Integrated Circuit (IC) or the like. Processor 302 may be utilized to perform computations required by Apparatus 300 or any of it subcomponents.

In some exemplary embodiments of the disclosed subject matter, Apparatus 300 may comprise an Input/Output (I/O) Module 305. I/O Module 305 may be utilized to provide an output to and receive input from a user, a computerized apparatus or another apparatus similar to Apparatus 300.

In some exemplary embodiments, Apparatus 300 may comprise a Memory 307. Memory 307 may be a hard disk drive, a Flash disk, a Random Access Memory (RAM), a memory chip, or the like. In some exemplary embodiments, Memory 307 may retain program code operative to cause Processor 302 to perform acts associated with any of the subcomponents of Apparatus 300.

Transient Operation Identifier 320 may be configured to identify transient operations. In some exemplary embodiments, Transient Operation Identifier 320 may be configured to override pre-determined TO definitions and determine an operation not be handled as a TO in view of a number of successive TOs, elapsed time since last PO, or the like.

Operation ID Allocator 330 may be configured to allocate an operation ID to an operation. In some exemplary embodiments, TOs may be allocated an operation ID by increasing a minor number of an operation ID of a preceding operation. In some exemplary embodiments, POs may be allocated an operation ID by increasing a major number of an operation ID of a preceding operation. Additionally or alternatively, the operation ID may not comprise minor and major numbers.

Speculative Branch Management Module 340 may be configured to manage initiating dummy speculative branches and committing such branches, so as to ensure that POs are retained in the log and TOs are written to log only as part of writing log entries of POs and without incurring overhead to the TO operations themselves. In some exemplary embodiments, Speculative Branch Management Module 340 may be configured to initiate branches by creating a DSC which does not change the current configuration of the RSM.

Operation Implementer 350 may be configured to implement an operation, either TO, PO, DSC, or the like. Operation Implementer 350 may be configured to avoid writing to log TOs as they are received and handled, while ensuring that each PO is written to the log immediately.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a server that implements a replicated process in a Replicated State Machine (RSM) that utilizes a quorum system to agree upon an order of operations, said method comprising:
receiving a first operation in the RSM, wherein the first operation is a transient operation;
performing the first operation without storing the first operation in a persistent storage of the server;
receiving a second operation in the RSM, wherein the second operation is a persistent operation; and
storing the second operation in the persistent storage of the server and performing the second operation.

2. The computer-implemented method of claim 1, wherein said storing the second operation further comprises storing consecutive transient operations preceding the persistent operation, wherein the consecutive transient operations preceding the persistent operation comprise the first operation.

3. The computer-implemented method of claim 1, wherein the first operation is dropped and never retained to persistent storage.

4. The computer-implemented method of claim 1, wherein each operation in the RSM has an operation ID, wherein the operation ID comprises a major number and a minor number, wherein transient operations advance the minor number and persistent operations advance the major number.

5. The computer-implemented method of claim 1 further comprises:
opening a speculative branch prior to performing the first operation, wherein the speculative branch comprises operations speculatively agreed upon and not retained prior to a commit operation; and
committing the speculative branch in response to the second operation.

6. The computer-implemented method of claim 1, wherein the RSM implemented a Paxos-based quorum system.

7. The computer-implemented method of claim 6, wherein the replicated process is acting as a leader of the RSM.

8. The computer-implemented method of claim 1, wherein the transient operation is a dummy write operation useful to providing a consistent read operation in the RSM.

9. The computer-implemented method of claim 1, wherein the transient operation is an operation on a membership information of the RSM.

10. A server implementing a replicated process in a Replicated State Machine (RSM) that utilizes a quorum system to agree upon an order of operations, wherein the server comprises a processor, the processor being adapted to perform the steps of:
receiving a first operation in the RSM, wherein the first operation is a transient operation;
performing the first operation without storing the first operation in a persistent storage of the server;
receiving a second operation in the RSM, wherein the second operation is a persistent operation; and
storing the second operation in the persistent storage of the server and performing the second operation.

11. The server of claim 10, wherein said storing the second operation further comprises storing consecutive transient operations preceding the persistent operation, wherein the consecutive transient operations preceding the persistent operation comprise the first operation.

12. The server of claim 10, wherein the first operation is dropped and never retained to persistent storage.

13. The server of claim 10, wherein each operation in the RSM has an operation ID, wherein the operation ID comprises a major number and a minor number, wherein transient operations advance the minor number and persistent operations advance the major number.

14. The server of claim 10, wherein the processor is further adapted to perform:
opening a speculative branch prior to performing the first operation, wherein the speculative branch comprises operations speculatively agreed upon and not retained prior to a commit operation; and
committing the speculative branch in response to the second operation.

15. The server of claim 10, wherein the RSM implemented a Paxos-based quorum system.

16. The server of claim 15, wherein the replicated process is acting as a leader of the RSM.

17. The server of claim 10, wherein the transient operation is a dummy write operation useful to providing a consistent read operation in the RSM.

18. The server of claim 10, wherein the transient operation is an operation on a membership information of the RSM.

19. A computer program product comprising a non-transitory computer readable storage medium retaining program instructions, which program instructions when read by a processor of a server implementing a replicated process in a Replicated State Machine (RSM) that utilizes a quorum system to agree upon an order of operations, cause the processor to perform a method comprising:
receiving a first operation in the RMS, wherein the first operation is a transient operation;
performing the first operation without storing the first operation in a persistent storage of the server;
receiving a second operation in the RSM, wherein the second operation is a persistent operation; and
storing the second operation in the persistent storage of the server and performing the second operation.
